(19) United States
(12) Patent Application Publication
(10) Pub. No.: US 2012/0033710 A1
(43) Pub. Date: Feb. 9, 2012

(54) OPTICAL TEMPERATURE SENSOR

(75) Inventor: Young Soo Kim, Gwangju (KR)

(73) Assignee: OPTOPOWER CO., LTD., Gwangju (KR)

(21) Appl. No.: 13/264,517

(22) PCT Filed: Jun. 14, 2010
(86) PCT No.: PCT/KR2010/003801

§ 371 Date: Oct. 14, 2011

(30) Foreign Application Priority Data
Aug. 26, 2009 (KR) 10-2009-0079230
Apr. 16, 2010 (KR) 10-2010-0035183
Apr. 16, 2010 (KR) 10-2010-0035185

(51) Int. Cl. G01K 11/32

(52) U.S. Cl. 374/161; 374/E11.015

(57) ABSTRACT

The present invention relates to an optical temperature sensor, comprising: a housing; a light-transmitting unit, installed in the housing, for emitting light transmitted through an optical fiber into an inner space of the housing; and a bimetal device, movably installed in the housing, for varying the amount of transmitted light, wherein the optical temperature sensor is capable of measuring a temperature by using the amount of light, from the light transmitted via the optical fiber, which is shielded through bending due to a change in the temperature of the bimetal device, or using the amount of light, from the transmitted light, which is reflected and received. The optical temperature sensor has a simple structure and is not particularly restricted in terms of installation space.

### TECHNICAL FIELD

The present invention relates to an optical temperature sensor, and more particularly, to an optical temperature sensor for measuring temperature by detecting received light quantity that is changed in response to an operation of a bimetal device according to a temperature change.

### BACKGROUND ART

Various types of sensors for measuring temperature have been known. Recently, a structure capable of measuring temperature for facilities to be monitored in remote places using an optical fiber has been proposed.

An optical temperature sensor relating to the present invention is disclosed in Japanese Laid-Open Publication No. 55-080021. The optical temperature sensor senses a temperature change by allowing the bimetal vertically installed to a light beam emitted from an input stage optical fiber to shield the light beam according to a temperature change and detecting the light beam at an output stage optical fiber.

However, the temperature sensor does not accurately sense the temperature change since the input and output stages are configured of a single optical fiber and a detailed mechanism capable of sensing the temperature change is not described.

As another invention relating to the present invention, an optical fiber using optical fiber grating is disclosed in Korean Patent Application No. 1993-0006932. The temperature sensor using the optical fiber may be implemented.

The optical fiber uses a transmissive optical fiber grating. The transmissive optical fiber grating is created by inputting strong light to the optical fiber so as to generate interference. The optical fiber device is manufactured by a mechanism of breaking a phase matching condition by coupling the optical fiber grating with a polarizer, a mode canceller, or an echogenic coupler. The optical fiber device may be used for a polarizer, a wavelength filter, an optical switch, a logic device, a stress sensor, a temperature sensor, a multi-divider, or the like.

However, there are problems in that engraving the grating into the optical fiber increases manufacturing costs and facilities required to calculate temperature are complicated since the temperature is calculated by detecting a change in a peak wavelength.

### Disclosure

### Technical Problem

An object of the present invention is to provide an optical temperature sensor capable of measuring temperature by allowing a photo detector to detect light quantity shielded by a bimetal device moving according to a temperature change while simplifying a structure of the optical temperature sensor by using an optical fiber as it is.

### Technical Solution

Provided is an optical temperature sensor. The optical temperature sensor includes a housing, an optical transmitter mounted in the housing and emitting the light transmitted through an optical fiber to an inner space of the housing, and a bimetal device flexibly mounted in the housing so as to change transmitted light quantity, whereby the temperature is measured by changing the shielded light quantity of light transmitted through the optical fiber by a warpage of the bimetal device according to a temperature change or the light quantity received by reflecting the transmitted light, thereby providing the optical temperature sensor having less space limitation for the installation while simplifying the structure.

The exemplary embodiments of the present invention measure the temperature by changing the light quantity transmitted through the optical fiber by the warpage of the bimetal device according to the temperature change. Three exemplary embodiments are disclosed according to the number of input stage optical fibers and types of the input stage and the output stage.

A first exemplary embodiment of the present invention includes a housing, two input stage and output stage optical fibers in a straight line within the housing, and a bimetal device mounted between the input stage and output stage optical fibers so as to detect the light quantity shielded by the bimetal device in the photo detector mounted at the output stage, thereby calculating the temperature.

A configuration of the optical temperature sensor according to a first exemplary embodiment of the present invention is as follows.

The optical temperature sensor includes: a housing in which a first support part and a second support part are formed so as to be spaced apart from each other, while being protruded with respect to a base part; an input stage optical transmitter supported on the first support part to emit light transmitted through an optical fiber; an output stage optical transmitter spaced apart from each other to face the input stage optical transmitter and supported on the second support part so as to receive and transmit light emitted from the input stage optical transmitter through the optical fiber; and a bimetal device flexibly mounted in the housing so as to change light quantity transmitted to the output stage optical transmitter while going in and out a transmission path of light beam transmitted from the input stage optical transmitter to the output stage optical transmitter according to a temperature change.

Preferably, the input stage optical transmitter may include first and second input stage optical fibers that are supported on the first support part so as to separate from each other to emit transmitted light, the output end optical transmitter may include first and second output stage optical fibers, of which ends are supported on the second support part, facing the first and second input stage optical fibers so as to receive and transmit the light emitted from the first and second input stage optical fibers, and the bimetal device may be flexibly mounted in the housing between the first and second output stage optical fibers.

In addition, the optical temperature sensor may further include a light source; an optical splitter receiving the light emitted from the light source and separately transmitting the light to the first and second input stage optical fibers; first and second photo detectors detecting the light transmitted through the first and second output stage optical fibers; and a temperature calculator calculating temperature of an environment in which the housing is mounted from signals output in response to the light quantity transmitted from the first and second photo detectors.

According to the first exemplary embodiment of the present invention, the temperature calculator may include a lookup table in which temperature values corresponding to signals output from the first and second photo detectors are written.

A second exemplary embodiment of the present invention includes a housing, a reflecting surface mounted in the housing, an input stage optical transmitter mounted in the housing so as to emit light inclined to the reflecting surface at a position opposite to the reflecting surface, an output stage optical transmitter mounted in the housing so as to receive and transmit light emitted from the input stage optical transmitter and reflected from the reflecting surface at a position opposite to the reflecting surface, and an optical interference unit configured of a bimetal device mounted in the housing, which changes the light quantity transmitted to the output stage optical transmitter, thereby calculating the temperature.

A configuration of the optical temperature sensor according to a second exemplary embodiment of the present invention is as follows.

The optical temperature sensor includes: a housing; an optical transmitter mounted in the housing to emit light transmitted through an optical fiber to an inner space of the housing and receive light reflected within the housing; and an optical interference unit formed of a bimetal device flexibly mounted in the housing so as to change light quantity reversely transmitted in the optical transmitter direction while going in and out a transmission path of light beam emitted from the optical transmitter to the housing according to a temperature change.

According to an exemplary embodiment of the present invention, a surface opposite the optical transmitter of the housing may be provided with a reflecting surface reflecting light, the optical transmitter may include an input stage optical transmitter mounted in the housing to emit the light transmitted through the optical fiber so as to emit light inclined to the reflecting surface at a position opposite to the reflecting surface of the housing and an output stage optical transmitter mounted in the housing so as to receive and transmit through the optical fiber the light reflected from the reflecting surface among the light emitted to be inclined toward the reflecting surface from the input stage optical transmitter at the position opposite to the reflecting surface of the housing, and the optical interference unit may be flexibly mounted in the housing so as to change the light quantity transmitted to the output stage optical transmitter while going in and out a transmission path of light beam transmitted from the input stage optical transmitter to the output stage optical transmitter through the reflecting surface according to the temperature change.

In addition, the input stage optical transmitter may include first and second input stage optical fibers inserted so as to separate from each other through first and second input stage connection grooves inclinedly provided to the reflecting surface at the position opposite to the reflecting surface of the housing to emit the transmitted light, the output stage optical transmitter may include the first and second output stage optical fibers inserted so as to separate from each other through the first and second output stage connection grooves provided in the housing according to an angle direction symmetrical with each other with respect to an optical axis of the first and second input stage optical fibers based on the reflecting surface so as to receive and transmit light emitted from the first and second input stage optical fibers and reflected and transmitted from the reflecting surface, and the optical interference unit may be provided with the bimetal device that extends in a direction toward the reflecting surface from between the first input stage optical fiber and the second input stage optical fiber, such that the terminal portion of the bimetal device is flexibly mounted within the housing in a direction crossing the first input stage optical fiber and the second input stage optical fiber.

The optical interference unit may be formed in a structure in which one end of the bimetal device configured of first and second plates and having different thermal expansion coefficients so as to be bonded to each other is fixedly coupled to the housing and the other end thereof extending toward the reflecting surface is provided with an interference piece having a width expanding from the bimetal device toward the reflecting surface, and the interference piece may be formed to partially interfere light beam emitted from the first and second input stage optical fibers at temperature in which the first plate and the second plate of the bimetal device are aligned so as to be parallel with each other on a straight line.

In addition, the reflective optical temperature sensor may further include: a light source; an optical splitter receiving the light emitted from the light source and separately transmitting the light to the first and second input stage optical fibers; first and second photo detectors detecting the light transmitted through the first and second output stage optical fibers; and a temperature calculator calculating temperature of an environment in which the housing is mounted from signals output in response to the light quantity transmitted from the first and second photo detectors.

According to the second exemplary embodiment of the present invention, the optical interference unit may include: a bimetal device having one end fixedly mounted to the housing and the other end flexibly mounted to the housing; a reflector coupled with the other end of the bimetal device to reflect light emitted from the optical transmitter and change light quantity reflected to the optical transmitter according to the movement in response to the temperature change of the bimetal device; a photo detector detecting light reflected from the reflector and reversely transmitted through the optical fiber of the optical transmitter; and a temperature calculator calculating the temperature from signals output from the photo detector.

More preferably, the optical temperature sensor may further include: first and second circulators mounted on the first and second optical fibers to transmit the light transmitted from the light source to a first path continued to the housing direction and transmit the light reflected from the housing to a second path; an optical splitter receiving the light emitted from the light source and to separately transmit the received light to the first and second circulators; and first and second photo detectors detecting the light transmitted through the second path and outputs the detected light to the temperature calculator, wherein the optical transmitter may include first and second optical fibers facing the reflector and mounted so as to be spaced apart from each other.

A third exemplary embodiment of the present invention includes a housing, one input stage and two output stage optical fibers in a straight line within the housing, and a bimetal device mounted between the input stage and the output stage optical fibers so as to detect the light quantity shielded by the bimetal device in the photo detector mounted at the output stage, thereby calculating the temperature.

A configuration of the optical temperature sensor according to the third exemplary embodiment of the present invention is as follows.

The optical temperature sensor includes: a bimetal device having one end supported on the first support part protruded with respect to a base part and the other end flexibly mounted thereto; an input stage optical transmitter emitting light transmitted through the optical fiber of which the terminal portion is coupled with the bimetal device so as to be warped by interworking with the bimetal device; and an output stage optical transmitter mounted in the housing so as to face the input stage optical transmitter so that light quantity received through the optical fiber is varied in response to a change of a light path of a light beam transmitted to the input stage optical fiber corresponding to a movement of the bimetal device according to the temperature change.

In addition, the input stage optical transmitter may include a first input stage optical fiber of which the terminal portion is coupled with the bimetal device so as to interwork with each other, the output terminal optical transmitter may include first and second output stage optical fibers having ends supported on the housing to face the first input stage optical fiber so as to separately receive and transmit light emitted from the first input stage optical fiber when the bimetal device maintains a straight state, and the bimetal device may be flexibly mounted in the housing between the first and second output stage optical fibers.

The first input stage optical fiber may be coupled with any one plate of the bimetal device configured of a first plate and a second plate.

The optical temperature sensor may further include: a light source transmitting light to the first input stage optical fiber; first and second photo detectors detecting light transmitted through the first and second output stage optical fibers; and a temperature calculator calculating temperature of an environment in which the housing is mounted from signals output in response to the light quantity transmitted from the first and second photo detectors.

### Advantageous Effects

As set forth above, the optical temperature sensor according to the first exemplary embodiment of the present invention can measure the wide range of temperature while simplifying the structure of the optical temperature sensor, by varying the shielded light quantity of light transmitted through the optical fiber by the warpage of the bimetal device according to the temperature change.

The optical temperature sensor according to the second exemplary embodiment of the present invention can mitigate the space limitation for installation by aligning the optical fiber transmitting and receiving light at a portion opposite to the reflecting surface while simplifying the structure of the optical temperature sensor by varying the reflected and received light quantity of light transmitted through the optical fiber by the warpage of the bimetal device according to the temperature change.

The optical temperature sensor according to the third exemplary embodiment of the present invention can measure the temperature by varying the light emitting direction and varying the received light quantity of the output stage optical fiber receiving light, by the warpage of the input stage optical fiber coupled so as to interwork with the bimetal device transmitting light according to the temperature change, thereby simplifying the structure of the optical temperature sensor.

### DESCRIPTION OF DRAWINGS

The above and other objects, features and advantages of the present invention will become apparent from the following description of preferred embodiments given in conjunction with the accompanying drawings, in which:

FIG. 1 is a perspective view of an optical temperature sensor according to a first exemplary embodiment of the present invention.

FIG. 2 is a control system circuit diagram of an optical temperature sensor of FIG. 1.

FIGS. 3 and 4 are diagrams for describing a state in which light quantity transmitted through the first and second output stage optical fibers by the bimetal modification of FIG. 1 is changed.

FIG. 5 is a perspective view of an optical temperature sensor according to a second exemplary embodiment of the present invention.

FIG. 6 is a cross-sectional view of an optical temperature sensor of FIG. 5.

FIG. 7 is a diagram showing an optical trace by extracting some elements of the optical temperature sensor of FIG. 5.

FIG. 8 is a control system circuit diagram of an optical temperature sensor of FIG. 5.

FIGS. 9 and 11 are diagrams for describing a state in which light quantity transmitted through the first and second output stage optical fiber by the modifications of the bimetal device of FIG. 5 is changed.

FIG. 12 is a diagram showing an optical temperature sensor according to another exemplary embodiment different from the second exemplary embodiment of the present invention.

FIG. 13 is a perspective view of an optical temperature sensor according to a third exemplary embodiment of the present invention.

FIG. 14 is a control system circuit diagram of an optical temperature sensor of FIG. 13.

FIGS. 15 and 17 are diagrams for describing a state in which light quantity transmitted through the first and second output stage optical fibers by the modifications of the bimetal device of FIG. 13 is changed.

### BEST MODE

Hereinafter, an optical temperature sensor according to exemplary embodiments of the present invention will be described in more detail with reference to the accompanying drawings.

First, an optical temperature sensor according to a first exemplary embodiment of the present invention will be described below.

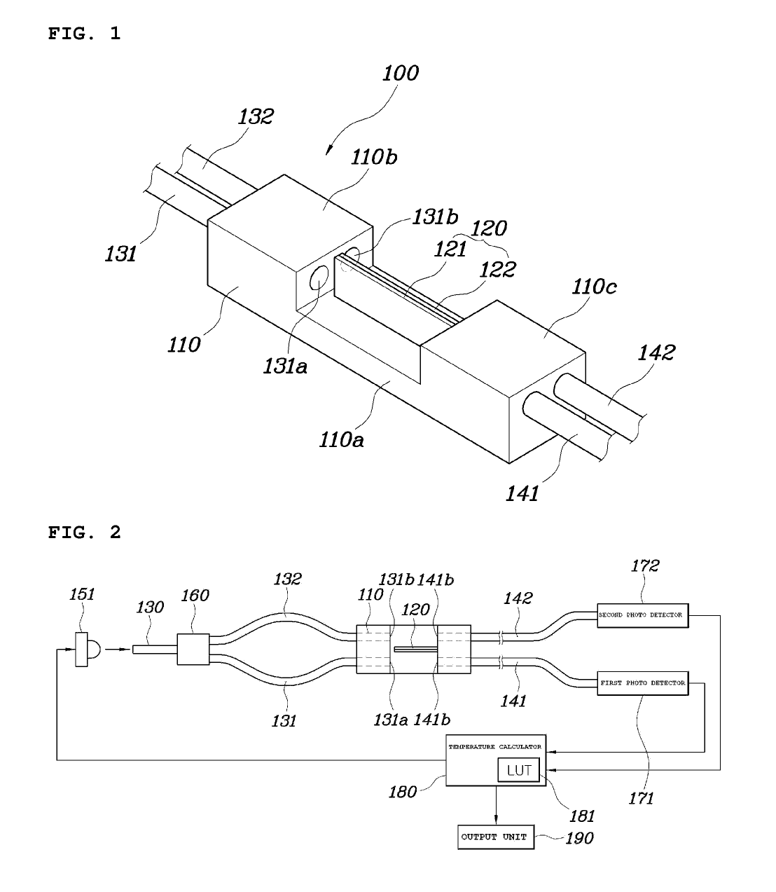

FIG. 1 is a perspective view of an optical temperature sensor according to the present invention and FIG. 2 is a control system circuit diagram of an optical temperature sensor of FIG. 1.

Referring to FIGS. 1 and 2, an optical temperature sensor 100 includes a housing 110, a bimetal device 120, a light source 151, an optical splitter 160, first and second input stage optical fibers 131 and 132, first and second output stage optical fibers 141 and 142, first and second photo detectors 171 and 172, and a temperature calculator 180.

The housing 110 has a structure in which a first support part 110b and a second support part 110c are formed so as to be protruded from each other with respect to the base part 110a.

Although not shown, a cover may be further provided so as to interrupt the input of the external light into the spaced space between the first support part 110b and the second support part 110c of the housing 110.

As an input stage optical transmitter, the first and second input stage optical fibers 131 and 132 mounted so as to be supported on the first support part 110b and emitting the transmitted light are used.

Ends of the first and second input stage optical fibers 131 and 132 are each connected to the optical splitter 160 and the other ends, that is, terminals 131a and 132a thereof are supported on the first support part 110b of the housing 110 so as to be separated from each other, thereby emitting the transmitted light toward the first and the second output stage optical fibers 141 and 142 through the spaced space

As the output stage optical transmitter, the first and second output stage optical fibers 141 and 142 spaced apart from each other so as to face the first and second input stage optical fibers 131 and 132 and mounted so as to be supported on the second support part 110c are used so as to receive and transmit the light emitted from the first and second input stage optical fibers 131 and 132 that are the input stage optical transmitter.

The bimetal device 120 has a structure in which first and second plates 121 and 122 made of a material having different thermal expansion coefficients are bonded to each other.

The bimetal device 120 may be flexibly mounted within a housing so as to change light quantity transmitted to the first and second output stage optical fibers 141 and 142 while going in and out a transmission path of light beam transmitted to the first and second output stage optical fibers 141 and 142 from the first and second input stage optical fibers 131 and 132 due to the warpage of the bimetal device 120 in a horizontal direction according to the temperature change.

That is, one end of the bimetal device 120, which is flexibly mounted in the housing 110 between the first support part 110b and the second support part 110c, may be fixedly mounted in the housing 110 between first and second output stage optical fibers 141 and 142. In addition, the bimetal device 120 is mounted in parallel with a direction of the first and second input stage optical fibers 131 and 132.

The bimetal device 120 is warped left and right according to the peripheral temperature change. As a result, the bimetal device 120 goes in and out the path of the light beam from the first and second input stage optical fibers 131 and 132 to the first and second output stage optical fibers 141 and 142 due to the warpage, thereby controlling a cross sectional area of the light beam that may be shielded.

In order to increase the temperature measurement precision due to the warpage of the bimetal device 120, the first and second plates 121 and 122 of the bimetal device 120 are disposed so as to partially cover a light emitting region of the first and second input stage optical fibers 131 and 132 equally to each other, under a temperature condition so that the first and second plates 121 and 122 of the bimetal device are maintained in parallel with each other. In this case, the light quantity received in each of the first and second output stage optical fibers 141 and 142 is fluctuated to each other by a minute warpage of the bimetal device 120, thereby increasing the temperature measurement precision. As the light source 151, a light emitting diode may be used.

The optical splitter 160 separately transmits light transmitted from a leading end optical fiber 130 receiving light emitted from the light source 151 to the first and second input stage optical fibers 131 and 132.

The first and second photo detectors 171 and 172 detect the light transmitted through the first and second output stage optical fibers 141 and 142 to output electrical signals corresponding to the detected light quantity.

The temperature calculator 180 calculates the temperature of the environment in which the housing 110 is mounted from signals output corresponding to the light quantity transmitted from the first and second photo detectors 171 and 172.

The temperature calculator 180 calculates the temperature of the environment in which a lookup table (LUT) 181 written with temperature values output corresponding to the signals output from the first and second photo detectors 171 and 172 is installed.

An output unit 190 outputs the temperature values controlled and calculated by the temperature calculator 180. As the output unit 190, a display unit displaying the temperature values may be used in the case of a short distance and a transmitter transmitting the temperature value calculated in wireless or wired in the case of a long distance may be used.

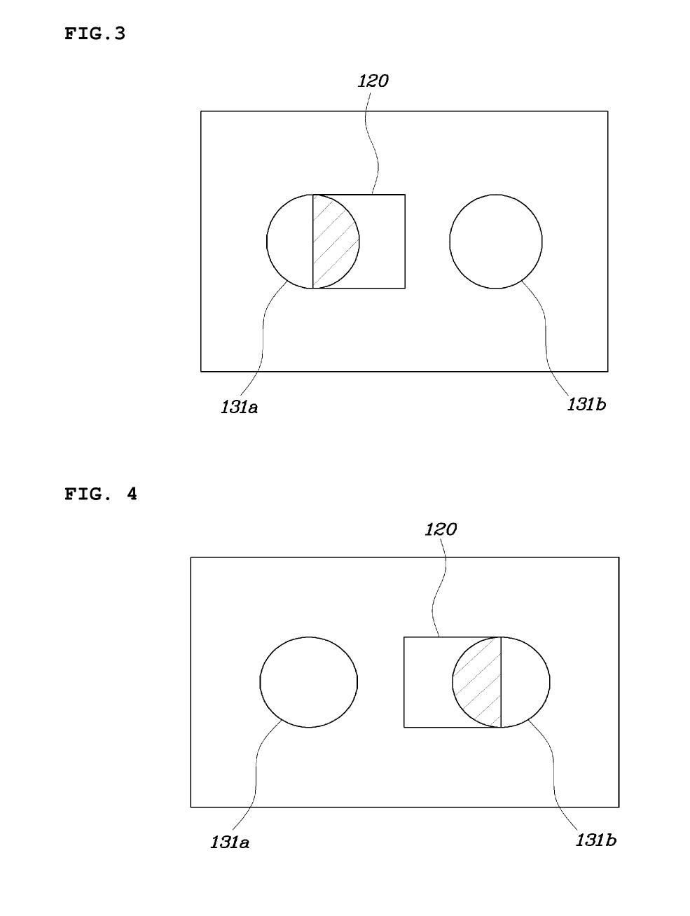

In the optical temperature sensor, when the second plate 122 of the bimetal device is warped to the first plate 121 of the bimetal device by making the temperature higher than the basic temperature making the first and second plates 121 and 122 of the bimetal device 120 so as to be maintained in parallel with each other, the light quantity received through the second output stage optical fiber 142 of the first and second output stage optical fibers 141 and 142 is further reduced at the time of non-shielding, if some of an end 131b of the second input stage optical fiber 132 of ends 131a and 131b of the first and second input stage optical fiber is covered, as shown in FIG. 3. Similarly, when the first plate 121 is warped to the second plate 122 by making the temperature lower than the basic temperature making the first and second plates 121 and 122 of the bimetal device 120 maintained so as to be parallel with each other, the light quantity received through the second output stage optical fiber 142 of the first and second output stage optical fibers 141 and 142 is further reduced than in the case of non-shielding, if some of the end 131a of the first input stage optical fiber 131 of the ends 131a and 131b of the first and second input stage optical fibers 131a and 131b is covered, as shown in FIG. 4.

As described above, the light quantity emitted from each of the first and second input stage optical fibers 131 and 132 is selectively shielded according to the temperature change and the light quantity received through each of the first and second output stage optical fibers 141 and 142 is changed by changing the shielded amount according to the temperature change. The temperature values corresponding to the variable value of the received light quantity are previously written in the lookup table 181 by the experiment.

Therefore, the temperature calculator 180 confirms the values output to correspond to the light quantity received from each of the first and second photo detectors 171 and 172 from the lookup table 181 to calculate the temperature.

Meanwhile, in the shown example, two output stage optical fibers 141 and 142 corresponding to two input stage optical fibers 131 and 132 are used so as to expand the temperature measurement range, but a single output stage optical fiber corresponding to a single input stage optical fiber may be used when the measurement is performed only in the measurement temperature range of the predetermined temperature or higher.

Hereinafter, an optical temperature sensor according to a second exemplary embodiment of the present invention will be described below.

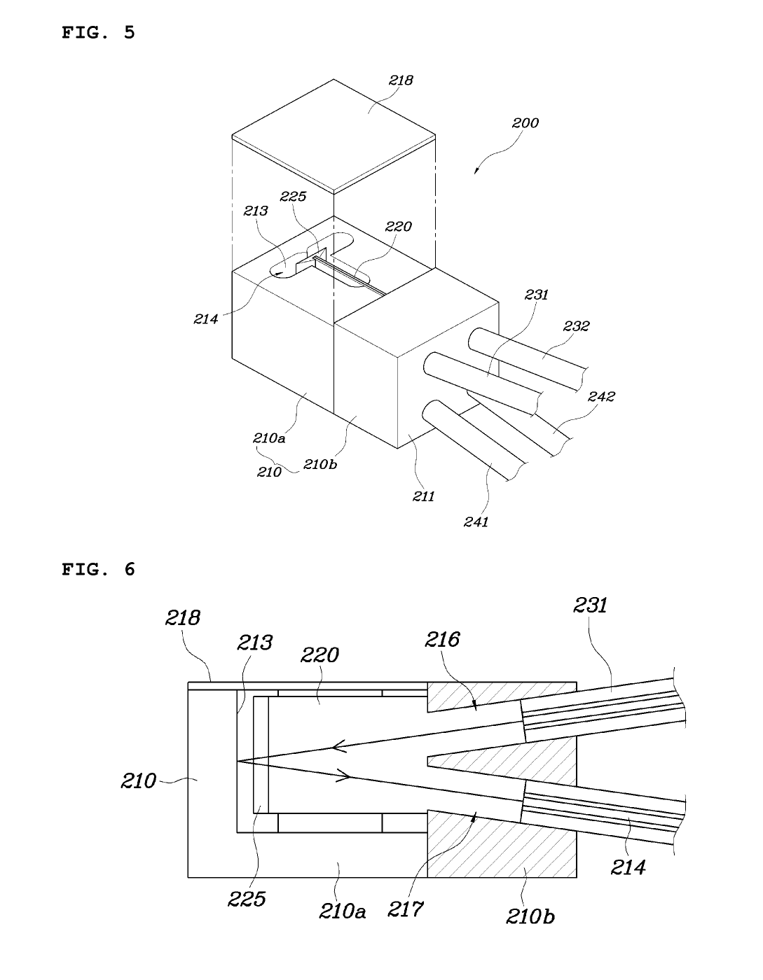

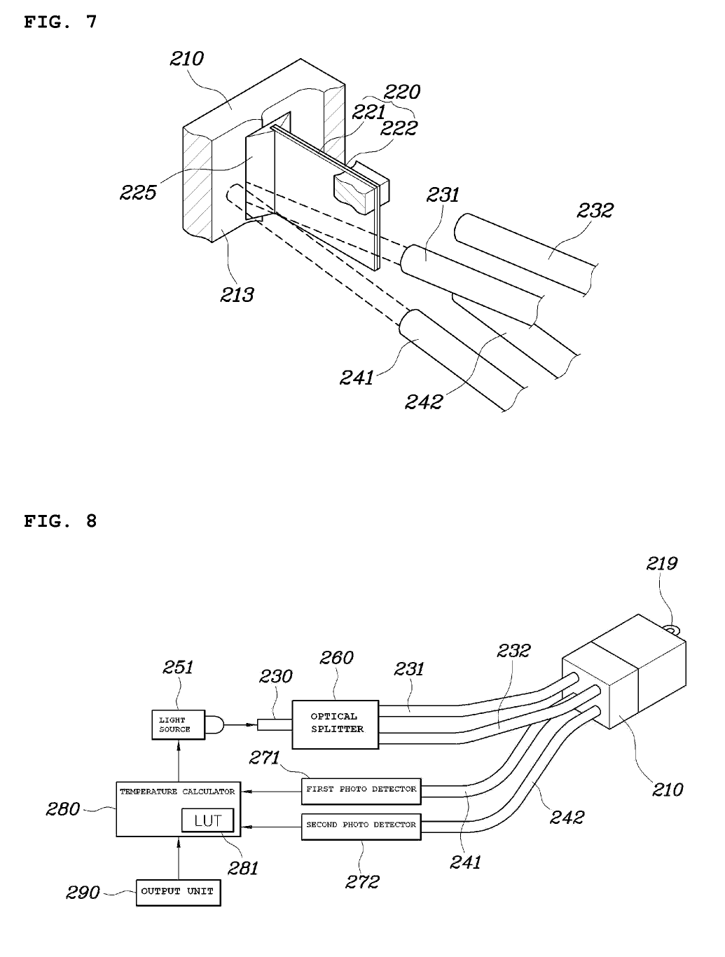

FIG. 5 is a perspective view of an optical temperature sensor according to a second exemplary embodiment of the present invention, FIG. 6 is a cross-sectional view of an optical temperature sensor of FIG. 5, FIG. 7 is a diagram showing an optical trace by extracting some elements of the optical temperature sensor of FIG. 5, and FIG. 8 is a control system circuit diagram of an optical temperature sensor of FIG. 5.

Referring to FIGS. 5 and 8, an optical temperature sensor 200 includes a housing 210, a bimetal device 220, a light source 251, an optical splitter 260, first and second input stage optical fibers 231 and 232, first and second output stage optical fibers 241 and 242, first and second photo detectors 271 and 272, and a temperature calculator 280.

The housing 210 is formed to have a squared case shape and an inside thereof is provided with an inner space 214 having a reflecting surface 213.

The inner space 214 of the housing 210 is formed to be able to sufficiently move according to the temperature change of the bimetal device 220 and an interference piece 225 as described below.

One side 211 of the housing 210 is provided with first and second input stage connection grooves 216 and first and second output stage connection grooves 217 that are each connected to the first and second input stage optical fibers 231 and 232 emitting light toward the reflecting surface 213 and the first and second optical fibers 241 and 242 receiving light reflected from the reflecting surface 213.

The first and second input stage connection groove 216 and the first and second outputs stage connection grooves 217 of the housing 210 are formed so as to extend by a predetermined length toward the reflecting surface 213 so as to have an inclined angle symmetrical with each other with respect to the reflecting surface 213.

The housing 210 is formed to have a first block body 210a made of a material having thermal conductivity while providing high reflectivity, for example, aluminum and a second block body 210b made of a synthetic resin material bonded to the first block body 210a and provided with the first and second input stage connection grooves 216 and the first and second output stage connection grooves 217 connected to the first and second input stage optical fibers 231 and 232 and the first and second output stage optical fibers 241 and 242. On the other hand, the housing 210 is made of a synthetic resin material but may be formed to have a reflecting layer of which the reflecting surface 213 is coated with a high reflecting material.

Reference numeral 218 is a shielding plate 218 bonded to the housing 210 so as to interrupt external light from being input into the inner space 214 in which the top portion of the first block body 210a is opened and reference numeral 219 is a ring to suspending the housing 210 within the space to be measured at the time of mounting the housing 210.

The first and second input stage optical fibers 231 and 232 used as the input stage optical transmitter are separately mounted from each other through the first and second input stage connection grooves 216 of the housing 210 so as to emit light inclined to the reflecting surface 213 at a position opposite to the reflecting surface 213 of the housing 210, thereby emitting light transmitted through the optical fiber.

Each end of the first and second input stage optical fibers 231 and 232 is connected to the optical splitter 260 and the other ends, that is, terminals thereof are mounted so as to separate from each other through the first and second input stage connection groove 216 of the housing 210, thereby emitting the transmitted light toward the reflecting surface 213.

As the output stage optical transmitter, the first and second output stage optical fibers 241 and 242 separately connected to each other through the first and second output stage connection grooves 217 provided in the housing 210 according to an angle direction symmetrical with each other with respect to the optical axis of the first and second input stage optical fibers 231 and 232 based on the reflecting surface 213 are used so as to receive and transmit light reflected from the reflecting surface 213 among light emitted to be inclined toward the reflecting surface 213 from the bottom portions of the first and second input stage optical fibers 231 and 232 at the position opposite to the reflecting surface 213 of the housing 210.

The optical interference unit includes the bimetal device 220 and the interference piece 225 that are flexibly mounted in the housing 210 so as to change the light quantity transmitted to the first and second output stage optical fibers 241 and 242 while going in and out a transmission path of light beam emitted from the first and second input stage optical fibers 231 and 232 and to the first and second output stage optical fibers 241 and 242 through the reflecting surface 213 according to the temperature change.

One end of the bimetal device 220 may be fixedly coupled to the housing 210 and the other end thereof may be flexibly mounted within the inner space 214, by bonding a first plate 221 and a second plate 222 having different thermal expansion coefficients to each other and

That is, the bimetal device 220 extends in a direction toward the reflecting surface 213 from between the first input stage optical fiber 231 and the second input stage optical fiber 232, such that the terminal portion thereof may be flexibly mounted within the housing 210 in a direction crossing the first input stage optical fiber 231 and the second input stage optical fiber 232.

The interference piece 225 is mounted at the other end, that is, the terminal portion toward the reflecting surface 213 of the bimetal device 220 and is formed in a triangular shape so as to have a width expanding from the bimetal device 220 toward the reflecting surface 213.

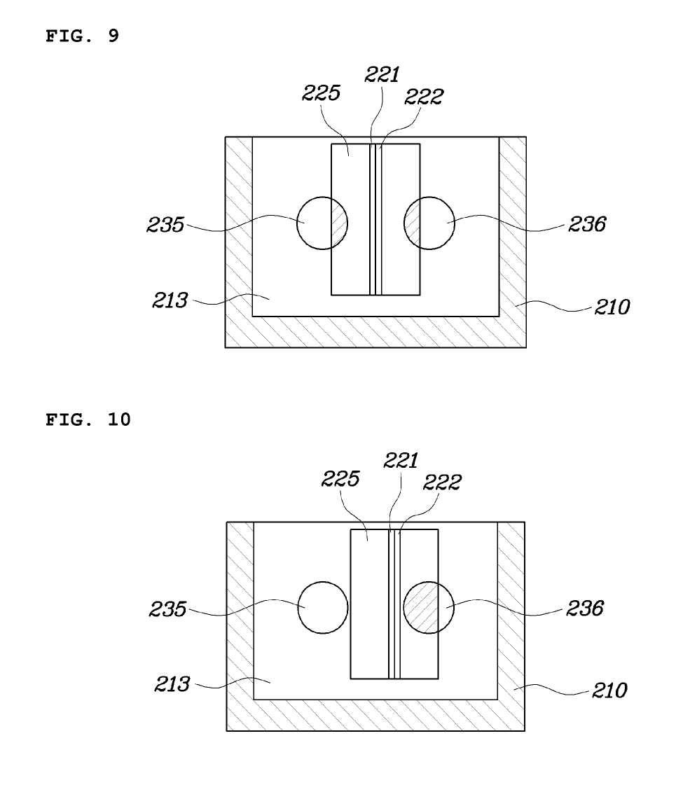

Preferably, as shown in FIG. 9, the interference piece 225 is formed to partially interfere the light beams 235 and 236 emitted from each of the first and second input stage optical fibers 231 and 232 under the temperature condition in which the first plate 221 and the second plate 222 of the bimetal device 220 are aligned so as to be parallel with each other on a straight line so that the light quantity received in the first and second output stage optical fibers 241 and 242 may be reduced to correspond to the interfered amount.

The optical interference unit controls a cross sectional area of the light beam received in the first and second output stage optical fibers 241 and 242 by going in and out the path of the light beam transmitted to the first and second output stage optical fibers 241 and 242 through the reflecting surface 213 from the first and second input stage optical fibers 231 and 232 due to the warpage of the bimetal device 220 left or right according to the peripheral temperature change.

Further, in order to increase the temperature measurement precision due to the warpage of the bimetal device 220, the first and second plates 220 and 221 of the bimetal device 220 are disposed so as to partially cover a light emitting region of the first and second input stage optical fibers 231 and 232 equally to each other, under a temperature condition so that the first and second plates 221 and 222 of the bimetal device 220 are maintained in parallel with each other. In this case, the light quantity received in each of the first and second output stage optical fibers 241 and 242 is fluctuated to each other even by a minute warpage of the bimetal device 220, thereby increasing the temperature measurement precision.

As the light source 251, a light emitting diode may be used.

The optical splitter 260 separately transmits light transmitted from a leading end optical fiber 230 receiving light emitted from the light source 251 to the first and second input stage optical fibers 231 and 232.

The first and second photo detectors 271 and 272 detect the light transmitted through the first and second output stage optical fibers 241 and 242 to output electrical signals corresponding to the detected light quantity.

The temperature calculator 280 calculates the temperature of the environment in which the housing 210 is mounted from signals output corresponding to the light quantity transmitted from the first and second photo detectors 271 and 272.

The temperature calculator 280 calculates the temperature of the environment in which the housing 210 is provided with a lookup table (LUT) 281 in which temperature values output corresponding to the signals output from the first and second photo detectors 271 and 272 are written.

An output unit 290 outputs the temperature values controlled and calculated by the temperature calculator 280. As the output unit 290, a display unit displaying the temperature values may be used in the case of a short distance and a transmitter transmitting the temperature value calculated in wireless or wired in the case of a long distance may be used.

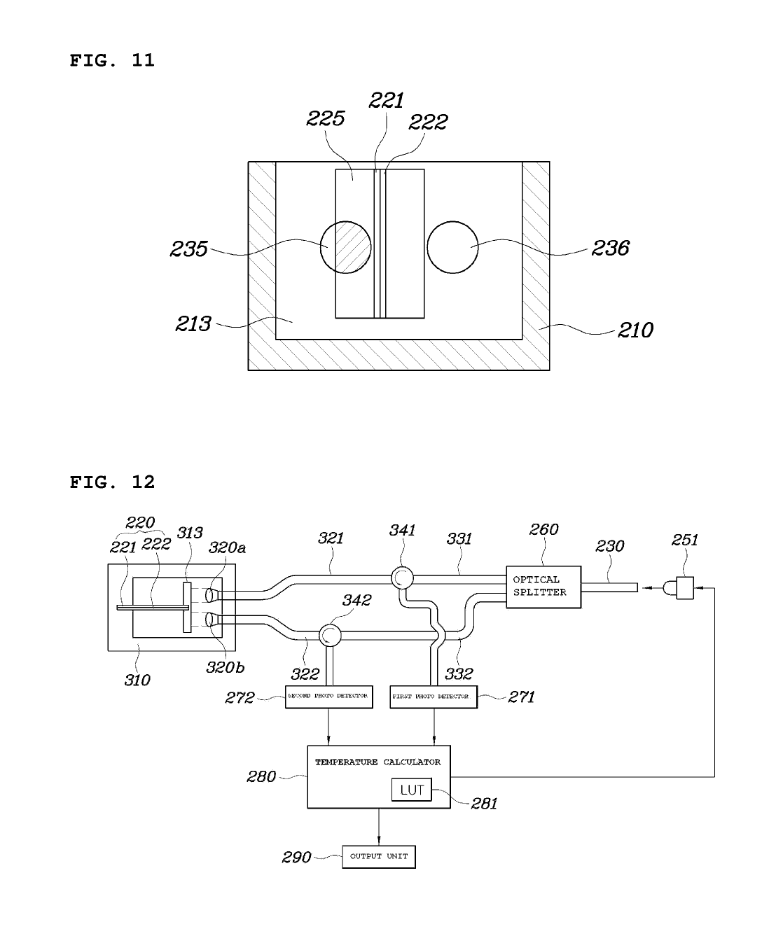

In the optical temperature sensor 200, when the first plate 221 is warped to the second plate 222 by making the temperature higher than the basic temperature making the first and second plates 221 and 222 of the bimetal device 220 so as to be maintained in parallel with each other, as shown in FIG. 10, the shielding region of the light beam 235 emitted from the first input stage optical fibers 231 is reduced and the shielding region of the light beam 236 emitted from the second input stage optical fiber 232 is increased, such that the light quantity received through the second output stage optical fiber 242 of the first and second output stage optical fibers 241 and 242 is further reduced. On the other hand, when the second plate 222 is warped to the first plate 221 by making the temperature lower than the basic temperature making the first and second plates 221 and 222 of the bimetal device 220 so as to be maintained in parallel with each other, as shown in FIG. 11, the shielding region of the light beam 235 emitted from the first input stage optical fibers 231 is larger than the shielding region of the light beam 236 emitted from the second input stage optical fiber 232, such that the light quantity received through the first output stage optical fiber 242 of the first and second output stage optical fibers 241 and 242 is further reduced.

As described above, the cross sectional area of the light beam emitted from each of the first and second input stage optical fibers 231 and 232 is selectively shielded according to the temperature change and the light quantity reflected through the reflecting surface 213 and received through each of the first and second output stage optical fibers 241 and 242 is changed by changing the shielded amount according to the temperature change. The temperature values corresponding to the variable value of the received light quantity are previously written in the lookup table 281 by the experiment.

Therefore, the temperature calculator 280 confirms the values output to correspond to the light quantity received from each of the first and second photo detectors 271 and 272 from the lookup table 281 to calculate the temperature.

Meanwhile, in the shown example, two output stage optical fibers 241 and 242 corresponding to two input stage optical fibers 231 and 232 are used so as to expand the temperature measurement range, but a single output stage optical fiber corresponding to a single input stage optical fiber may be used when the measurement is performed only in the measurement temperature range of the predetermined temperature or higher.

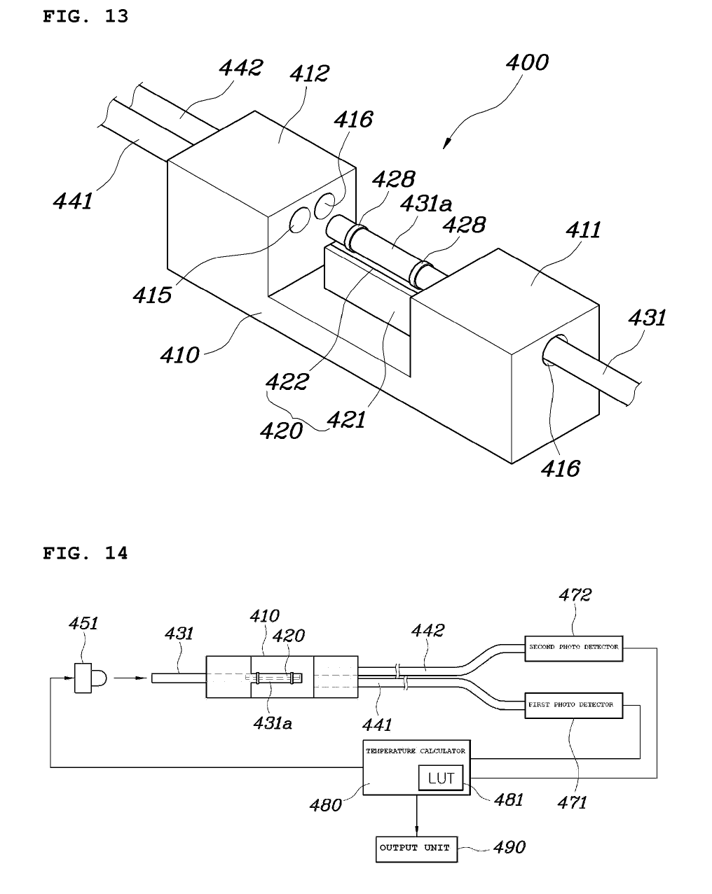

Meanwhile, differently from the shown example, so as to reduce the number of optical fibers connected to the housing, the temperature calculator may be build to calculate temperature by emitting light through the optical fiber and again receiving the reflected light from the same optical fiber and the example thereof is shown in FIG. 12. Components performing the same function as components shown above are denoted by the same reference numerals.

Referring to FIG. 12, the optical temperature sensor includes the housing 210, the bimetal device 220, first and second optical fibers 321 and 322, and first and second circulators 341 and 342.

One of the bimetal device 220 used as the optical interference unit is mounted so as to be supported on the housing 210 having the inner space and the flexible other end thereof is provided with a reflector 313 extending in a direction orthogonal to the extending direction.

The reflector 313 reflects the light emitted from each of the first and second optical fibers 321 and 322 used as the optical transmitter and changes the light quantity reflected to the optical fibers 321 and 322 according to the left and right movement of the bimetal device 220 according to the temperature change.

Reference numerals 320a and 320b are a collimating lens that converts the beam emitted and diffused from the first and second optical fiber into parallel light.

In this case, the size of the reflecting region may be determined so that the reflector 313 may partially reflect the light beam emitted from the first and second optical fibers 321 and 322 in the state in which the bimetal device 220 is maintained in a straight state without being warped as described with reference to FIG. 9.

The first and second circulators 341 and 342 transmit the light emitted from the light source 251 and separately transmitted from each of the first and second split optical fibers 331 and 332 in the optical splitter 260 to the first and second optical fibers 321 and 322 and transmits the light received in the first and second optical fibers 321 and 322 to the first and second photo detectors 271 and 272.

In this case, the first and second photo detectors 271 and 272 detect the light reflected from a reflector 313 and reversely transmitted through the first and second optical fibers 321 and 322.

The temperature calculator 280 calculates the temperature from the signal output from the first and second photo detectors 271 and 272 as described above.

The reflective optical temperature sensor may reduce the number of optical fiber connected to the housing 210. Hereinafter, an optical temperature sensor according to a third exemplary embodiment of the present invention will be described below.

FIG. 13 is a perspective view of an optical temperature sensor according to a third exemplary embodiment of the present invention and FIG. 14 is a control system circuit diagram of an optical temperature sensor of FIG. 13.

Referring to FIGS. 13 and 14, an optical temperature sensor 400 includes a housing 410, a bimetal device 420, a light source 451, a first input stage optical fiber 431, first and second output stage optical fibers 441 and 442, first and second output stage photo detectors 471 and 472, and a temperature calculator 480.

The housing 410 has a structure in which a first support part 411 and a second support part 412 are formed so as to be spaced apart from each other, while being protruded with respect to the base part.

Although not shown, a cover may be further provided so as to interrupt the input of the external light into the spaced space between the first support part 411 and the second support part 412 of the housing 410.

One end of the bimetal device 420 may be mounted to be supported on the first support part 411 and the other thereof may be flexibly mounted to extend in a direction toward the second support part 412.

The bimetal device 420 has a structure in which first and second plates 421 and 422 made of a material having different thermal expansion coefficients are bonded to each other.

The bimetal device 420 is mounted to the first support part 411 so as to be disposed at the center of the first and second output stage optical fibers 441 and 442 between the first and second output stage optical fibers 441 and 442.

The first input stage optical fibers 431 used as the input stage optical transmitter emits the transmitted light by coupling a terminal portions 431a with the bimetal device 420 so that the first input stage optical fiber 431 may be warped left and right by interworking with the bimetal device 420.

In the shown example, the first input stage optical fiber 431 is coupled with the second plate 422 of the bimetal device 420 by a coupling band 428.

Unlike the shown example, the first input stage optical stage 431 may be coupled with the second plate 422 through the first plate 421 of the bimetal device 420 or may be coupled with both of the first and second plates 421 and 422.

In this structure, the first input stage optical fiber 431 has an outer diameter larger than the first input stage optical fiber 431 on the first support part 411 and is mounted so as to be flexibly supported through a flexible support groove 414 formed so as to penetrate through the first support 411.

The first and second output stage optical fibers 441 and 442 used as the output stage optical transmitter are mounted so as to face the first input stage optical fiber 431 so that the received light quantity may be varied in response to the change of the light path of the light beam emitted from the first input stage optical fiber 431 corresponding to the movement of the bimetal device 420 according to the temperature change.

Reference numeral 415 is a first light receiving groove receiving in which the first output stage optical fiber 441 is inserted to receive light and reference numeral 416 is a second light receiving groove in which the second output stage optical fiber 441 is inserted to receive light.

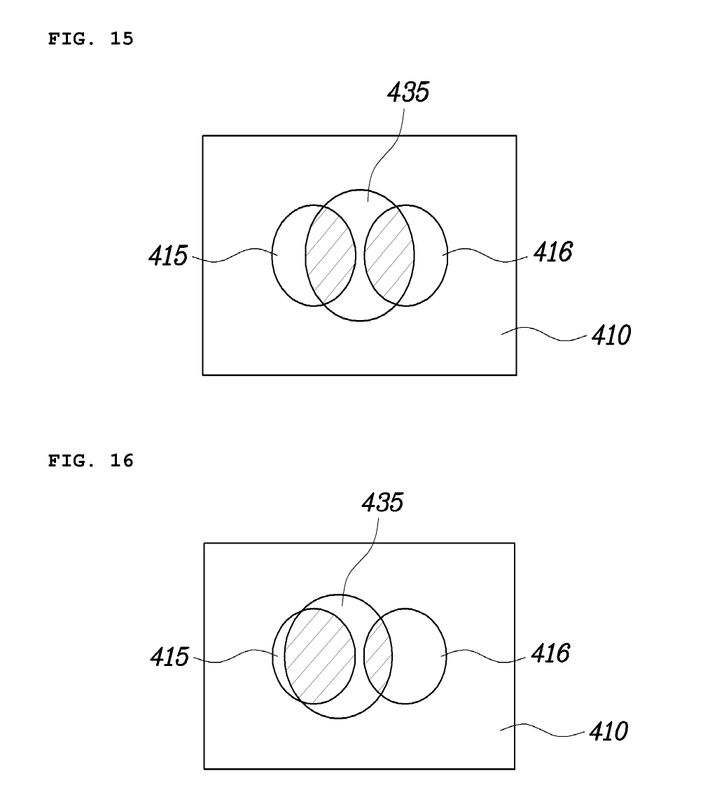

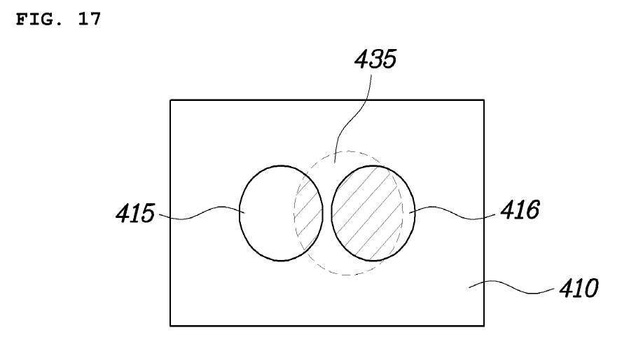

Preferably, in order to increase the temperature measurement precision by the warpage of the bimetal device 420, the first and second output stage optical fibers 441 and 442 are supported on the second support 412 so as to face each other at the position at which they are symmetrical with each other based on the first input stage optical fiber 431 as shown in FIG. 15 so that each of the first and second output stage optical fibers 441 and 442 may separately receive and transmit the light emitted from the first input stage optical fiber 431 when the bimetal device 420 maintains a straight state. In this case, the light quantity received in each of the first and second output stage optical fibers 441 and 442 is fluctuated to each other even by a minute warpage of the bimetal device 420, thereby increasing the temperature measurement precision.

Therefore, the trace of the light beam emitted from the terminal portion 431a of the first input stage optical fiber 431 is fluctuated by the warpage of the bimetal device 420 in the left and right directions according to the temperature change and thus, the light quantity transmitted to the first and second output stage optical fibers 441 and 442 is changed, thereby measuring the temperature.

As the light source 451, a light emitting diode may be used.

The first and second photo detectors 471 and 472 detect the light transmitted through the first and second output stage optical fibers 441 and 442 to output electrical signals corresponding to the detected light quantity.

The temperature calculator 480 calculates the temperature of the environment in which the housing 410 is mounted from signals output corresponding to the light quantity transmitted from the first and second photo detectors 471 and 472.

The temperature calculator 480 calculates the temperature of the environment in which the housing 481 is provided with a lookup table (LUT) 180 in which temperature values output corresponding to the signals output from the first and second photo detectors 471 and 472 are written.

An output unit 490 outputs the temperature values controlled and calculated by the temperature calculator 480. As the output unit 490, a display unit displaying the temperature values may be used in the case of a short distance and a transmitter transmitting the temperature value calculated in wireless or wired in the case of a long distance may be used.

In the optical temperature sensor, when the second plate 422 of the bimetal device is warped to the first plate 421 of the bimetal device by making the temperature higher than the basic temperature making the first and second plates 421 and 422 of the bimetal device 420 so as to be maintained in parallel with each other, as shown in FIG. 16, the light beam 435 emitted through the terminal of the first input stage optical fiber 431 is also warped to the first plate 421 to increase the light quantity received through the first output stage optical fiber 441 of the first and second output stage optical fibers 441 and 442 and reduce the light quantity received through the second output stage optical fiber 442. Similarly, when the first plate 421 of the bimetal device is warped to the second plate 422 of the bimetal device by making the temperature lower than the basic temperature making the first and second plates 421 and 422 of the bimetal device 420 so as to be maintained in parallel with each other, as shown in FIG. 17, the light beam 435 emitted through the terminal of the first input stage optical fiber 431 is also warped to the right to increase the light quantity received through the second output stage optical fiber 442 of the first and second output stage optical fibers 441 and 442 and reduce the light quantity received through the first output stage optical fiber 441.

The light quantity received in each of the first and second output stage optical fibers 441 and 442 is changed by the trace change of the light beam emitted from the first input stage optical fiber 431 mounted so that the terminal portion 431a of the first input stage optical fiber 431 is warped by interworking with the bimetal device 420 and the temperature value corresponding to the variable value of the received light quantity is previously written in the lookup table 481 by the experiment.

Therefore, the temperature calculator 480 confirms the values output to correspond to the light quantity received from each of the first and second photo detectors 471 and 472 from the lookup table 481 to calculate the temperature.

Meanwhile, in the shown example, two output stage optical fibers 441 and 442 corresponding to one input stage optical fiber 431 are used so as to expand the temperature measurement range, but the single output stage optical fiber may be used when the measurement is performed only in the measurement temperature range of the predetermined temperature or higher.

1. An optical temperature sensor, comprising:
a housing in which a first support part and a second support part are formed so as to be spaced apart from each other, while being protruded with respect to a base part;
an input stage optical transmitter supported on the first support part to emit light transmitted through an optical fiber;
an output stage optical transmitter spaced apart from each other to face the input stage optical transmitter and supported on the second support part so as to receive and transmit light emitted from the input stage optical transmitter through the optical fiber; and
a bimetal device flexibly mounted in the housing so as to change light quantity transmitted to the output stage optical transmitter while going in and out a transmission path of light beam transmitted from the input stage optical transmitter to the output stage optical transmitter according to a temperature change,
wherein the input stage optical transmitter includes first and second input stage optical fibers that are supported on the first support part so as to separate from each other to emit transmitted light,
the output end optical transmitter includes first and second output stage optical fibers, of which ends are supported on the second support part, facing the first and second input stage optical fibers so as to receive and transmit the light emitted from the first and second input stage optical fibers, and
the bimetal device is flexibly mounted in the housing between the first and second output stage optical fibers.

2. The optical temperature sensor of claim 1, further comprising:
a light source;
an optical splitter receiving the light emitted from the light source and separately transmitting the light to the first and second input stage optical fibers;
first and second photo detectors detecting the light transmitted through the first and second output stage optical fibers; and
a temperature calculator calculating temperature of an environment in which the housing is mounted from signals output in response to the light quantity transmitted from the first and second photo detectors.

3. The optical temperature sensor of claim 2, wherein the temperature calculator includes a lookup table in which temperature values corresponding to signals output from the first and second photo detectors are written.

4. A reflective optical temperature sensor, comprising:
a housing;
an optical transmitter mounted in the housing to emit light transmitted through an optical fiber to an inner space of the housing and receive light reflected within the housing; and
an optical interference unit formed of a bimetal device flexibly mounted in the housing so as to change light quantity reversely transmitted in the optical transmitter direction while going in and out a transmission path of light beam emitted from the optical transmitter to the housing according to a temperature change.

5. The reflective optical temperature sensor of claim 4, wherein a surface opposite the optical transmitter of the housing is provided with a reflecting surface reflecting light,
the optical transmitter includes an input stage optical transmitter mounted in the housing to emit the light transmitted through the optical fiber so as to emit light inclined to the reflecting surface at a position opposite to the reflecting surface of the housing and an output stage optical transmitter mounted in the housing so as to receive and transmit through the optical fiber the light reflected from the reflecting surface among the light emitted to be inclined toward the reflecting surface from the input stage optical transmitter at the position opposite to the reflecting surface of the housing, and
the optical interference unit is flexibly mounted in the housing so as to change the light quantity transmitted to the output stage optical transmitter while going in and out a transmission path of light beam transmitted from the input stage optical transmitter to the output stage optical transmitter through the reflecting surface according to the temperature change.

6. The reflective optical temperature sensor of claim 5, wherein the input stage optical transmitter includes first and second input stage optical fibers inserted so as to be separated from each other through first and second input stage connection grooves inclinedly provided to the reflecting surface at the position opposite to the reflecting surface of the housing to emit the transmitted light,
the output stage optical transmitter includes the first and second output stage optical fibers inserted so as to separate from each other through the first and second output stage connection grooves provided in the housing according to an angle direction symmetrical with each other with respect to an optical axis of the first and second input stage optical fibers based on the reflecting surface so as to receive and transmit light emitted from the first and second input stage optical fibers and reflected and transmitted from the reflecting surface, and
the optical interference unit is provided with the bimetal device that extends in a direction toward the reflecting surface from between the first input stage optical fiber and the second input stage optical fiber, such that the terminal portion of the bimetal device is flexibly mounted within the housing in a direction crossing the first input stage optical fiber and the second input stage optical fiber.

7. The reflective optical temperature sensor of claim 6, wherein the optical interference unit is formed in a structure in which one end of the bimetal device configured of first and second plates and having different thermal expansion coefficients so as to be bonded to each other is fixedly coupled to the housing and the other end thereof extending toward the reflecting surface is provided with an interference piece having a width expanding from the bimetal device toward the reflecting surface, and
the interference piece is formed to partially interfere light beam emitted from the first and second input stage optical fibers at a temperature in which the first plate and the second plate of the bimetal device are aligned so as to be parallel with each other on a straight line.

8. The reflective optical temperature sensor of claim 7, further comprising:
a light source;
an optical splitter receiving the light emitted from the light source and separately transmitting the light to the first and second input stage optical fibers;
first and second photo detectors detecting the light transmitted through the first and second output stage optical fibers; and
a temperature calculator calculating temperature of an environment in which the housing is mounted from signals output in response to the light quantity transmitted from the first and second photo detectors.

9. The reflective optical temperature sensor of claim 4, wherein the optical interference unit includes:
a bimetal device having one end fixedly supported on the housing and the other end flexibly mounted to the housing;
a reflector coupled with the other end of the bimetal device to reflect light emitted from the optical transmitter and change light quantity reflected to the optical transmitter according to the movement in response to the temperature change of the bimetal device;
a photo detector detecting light reflected from the reflector and reversely transmitted through the optical fiber of the optical transmitter; and
a temperature calculator calculating the temperature from signals output from the photo detector.

10. The reflective optical temperature sensor of claim 9, further comprising:
first and a second circulators mounted on the first and second optical fibers to transmit the light transmitted from the light source to a first path continued to the housing direction and transmit the light reflected from the housing to a second path;
an optical splitter receiving the light emitted from the light source and to separately transmit the received light to the first and second circulators; and
first and second photo detectors detecting the light transmitted through the second path and outputs the detected light to the temperature calculator,
wherein the optical transmitter includes first and second optical fibers facing the reflector and mounted so as to be spaced apart from each other.

11. An optical temperature sensor, comprising:
a bimetal device having one end supported on the first support part protruded with respect to a base part and the other end flexibly mounted thereto;
an input stage optical transmitter emitting light transmitted through the optical fiber of which the terminal portion is coupled with the bimetal device so as to be warped by interworking with the bimetal device; and
an output stage optical transmitter mounted in the housing so as to face the input stage optical transmitter so that light quantity received through the optical fiber is varied in response to a change of a light path of a light beam transmitted to the input stage optical fiber corresponding to a movement of the bimetal device according to the temperature change.

12. The optical temperature sensor of claim 11, wherein the input stage optical transmitter includes a first input stage optical fiber of which the terminal portion is coupled with the bimetal device so as to interwork with each other,
the output terminal optical transmitter includes first and second output stage optical fibers having ends supported on the housing to face the first input stage optical fiber so as to separately receive and transmit light emitted from the first input stage optical fiber when the bimetal device maintains a straight state, and
the bimetal device is flexibly mounted in the housing between the first and second output stage optical fibers.

13. The optical temperature sensor of claim 12, wherein the first input stage optical fiber is coupled with any one plate of the bimetal device configured of a first plate and a second plate.

14. The optical temperature sensor of claim 13, further comprising:
a light source transmitting light to the first input stage optical fiber;
first and second photo detectors detecting light transmitted through the first and second output stage optical fibers; and
a temperature calculator calculating temperature of an environment in which the housing is mounted from signals output in response to the light quantity transmitted from the first and second photo detectors.
